(19) United States
(12) Patent Application Publication
(10) Pub. No.: US 2005/0045562 A1
(43) Pub. Date: Mar. 3, 2005

(54) Method for removal of amine contaminants from liquefied petroleum gas

(75) Inventors: Bryan S. Memmott, Barrington, IL (US); Robert E. Davis, Hinsdale, IL (US)

Correspondence Address: GODFREY & KAHN S.C., 780 NORTH WATER STREET, MILWAUKEE, WI, 53202, US

(73) Assignee: FUEL TREATMENT TECHNOLOGIES, LLC

(21) Appl. No.: 10/959,451

(22) Filed: Oct. 6, 2004

Related U.S. Application Data
(63) Continuation of application No. PCT/US03/10170, filed on Apr. 3, 2003.
Application No. PCT/US03/10170 is a continuation of application No. 10/119,969, filed on Apr. 10, 2002.

(51) Int. Cl. C02F 1/28

(52) U.S. Cl. 210/690

(57) ABSTRACT

A filter and a method of using the filter for removing contaminants from LPG. The LPG enters the filter through an inlet and passes through a first filtration element where chemical contaminants are removed by a chemical entrapping agent, preferably a zeolite. Subsequently, the LPG passes through a second filtration element where particulate contaminants are removed. The invention is also a method of removing contaminants from LPG including the step of routing the flow of the LPG through chemical and particulate filter elements so that chemical and particulate contaminants are sequentially removed.

### CROSS-REFERENCE TO RELATED APPLICATION

This continuation application claims priority under 35 U.S.C. § 120 to International Application No. PCT/US2003/010170, filed on Apr. 3, 2003 and designating the United States, which claimed priority to U.S. application Ser. No. 10/119,969, filed Apr. 10, 2002. International Application No. PCT/US2003/010170 and U.S. application Ser. No. 10/119,969 are incorporated herein by reference in their entireties for all purposes.

### FIELD OF THE INVENTION

The present invention relates generally to an apparatus and method for removing impurities or, equivalently, contaminants from liquefied petroleum gas. More specifically, this invention relates to a filter including a chemical contaminant entrapping agent and a method of using the filter to remove low molecular weight chemical contaminants, particularly amines, from liquefied petroleum gas.

### BACKGROUND OF THE INVENTION

Liquefied petroleum gas (LPG) is a well-known and extremely valuable fuel source in our present day economy. Commercial uses of LPG are varied and range from powering forklift truck engines to providing the heating requirements for residential homes. Indeed, LPG has been recognized as a convenient and economical fuel for a myriad of applications.

However, energy sources, especially hydrocarbon-based fuels, have recently come under increased scrutiny spurred by concerns over environmental pollution and workplace safety. Many fuel sources have had tighter restrictions placed on their contaminant content. For example, contaminant sulfur compounds present in diesel fuels, known to be major contributors to air pollution, have been targeted by the Federal government for dramatic reduction in the near future. As well, LPG has been evaluated and certain requirements have been suggested for improving its qualities and characteristics to move toward a more environmental and workplace-friendly energy source.

Traditionally, LPG for use in commercial applications has been obtained by one of two approaches: (1) LPG may be obtained as a constituent of crude oil through petroleum refining processes; and (2) LPG has been produced by “cracking” hydrocarbons of greater chain length in various chemical processes. LPG obtained by either methodology may then be stored, shipped and supplied to an end use in the gaseous state, or as will be described below, in the pressurized LPG form. LPG provides a convenient and economical approach to handling and transporting petroleum gas.

Various end use applications utilize propane vapor drawn from an LPG storage tank. A vapor withdrawal system facilitates this process by drawing the heat necessary to vaporize the LPG from contact with the bulk tank itself. In turn, the bulk tank may draw heat from the surrounding ambient air. Two variables are recognized which affect the rate of vaporization: (1) as the LPG level falls in the tank, the rate of vaporization lowers due to the loss of contact between the LPG and the tank; and (2) the rate of vaporization is lowered when the temperature of the ambient air surrounding the tank is low.

Although the vapor withdrawal system described above is adequate where a large LPG storage tank is involved, certain LPG applications utilizing small LPG storage tanks require a different configuration to provide adequate propane vaporization. For example, on a mobile engine application such as a forklift, only 30-35 lbs. of LPG is carried in a storage tank. The small tank size and small volume of LPG combine to provide insufficient propane vaporization at the tank to maintain proper engine performance.

To solve the above-described problem, a vaporizer regulator is set apart from the tank and allows the LPG to draw the necessary heat to vaporize effectively. Unfortunately, vaporizer regulators have long been known to suffer from residue buildup due to contaminants contained within the LPG depositing on the interior surfaces of the regulator. This buildup is especially troublesome where the LPG was originally obtained through chemical “cracking” processes which inherently leave low levels of unreacted reagent and reaction side products in the major LPG product. Contaminants may further include additives, surfactants, or surface acting agents.

Residue buildup is not limited to the regulator but commonly occurs in downstream system components including, but not limited to, fuel injectors and air/gas mixers. Residue buildup ultimately results in engine starting difficulties and inconsistent engine performance in as few as 500 hours of system operation. Disassembly of the system is required and the generally sticky, or gummy, residues built up on the interior surfaces of the regulator must be thoroughly removed. Five hundred hours of system operation is considered sub-optimal and an industry standard of 5000 hours is being presently considered by the Environmental Protection Agency (EPA) as a minimum durability standard. New stricter regulations published by the EPA in late 2002 are already scheduled to take effect in 2004. In 2007, EPA regulations will require transient cycle testing for certification and compliance with significantly lower emissions limits, most likely also including the 5000 hour minimum durability standard. Considerable efforts toward improving LPG technology are now underway as exemplified by the Propane Education and Research Council's recent award of $1.39 million U.S. dollars to the Southwest Research Institute to study propane fuel system technologies and their ability to meet EPA 2007 standards for large spark-ignited (LSI) non-road engines (e.g., fork lift tractors).

Several solutions to the residue buildup problem described above are available but none offer a convenient, cost-effective and reliable answer. For instance, a frequent regimen of regulator service including a total dismantling of the regulator is labor intensive and leads to tremendous downtime for devices requiring such regular maintenance. Alternatively, regulators have been equipped with thermostats and heating/cooling combinations in an attempt to discourage residues from depositing on the sensitive interiors of the regulators. However, contaminants may still deposit in components of the engine system downstream of the regulator such as the air intake manifold and on the engine intake valve itself. Thus, this approach has limited applicability.

As well, chemical additives have been provided in the LPG to dissolve the residue in the regulator and pass it on through the engine. Such approach is clearly undesirable due to the presence of additional chemicals that may pose environmental and workplace hazards after passing through the engine. Exhaust emissions aside, it is unclear that current additives are effective in dissolving the major contaminants in LPG and additives also raise fuel handling issues regarding treated versus untreated LPG.

In light of the above described problem, it is desirable to have an apparatus and method by which the contaminants present in LPG may be effectively reduced or removed. It is especially desirable to obtain technology suitable for significantly improving LPG fuel quality and reducing emissions to ensure adequate engine and emissions performance in LPG engines with respect to present and future durability requirements.

### SUMMARY OF THE INVENTION

Therefore, in view of the problems associated with the previously described solutions, it is an object of the present invention to provide an apparatus and method by which the contaminants present in LPG may be effectively reduced or removed. In particular, the present invention is based upon the inventors' discovery that the vast majority of troublesome buildup in LPG systems is due to low molecular weight chemical contaminants, primarily low molecular weight amines. These contaminants may be introduced into LPG during processing, transport and/or storage. In recognizing the cause of the problem, the inventors arrived at the apparatus and methods described and claimed herein.

In a preferred embodiment, a filter according to the invention will include an upper housing equipped with an inlet. The inlet is capable of receiving LPG from upstream of the filter. The upper housing also includes an outlet capable of conveying LPG downstream of the filter. A lower housing is removably attached to the upper housing and communicates with the inlet. An inner assembly having first and second ends is removably attached to the upper housing and further communicates at its first end with the outlet. The inner assembly is disposed within and spaced apart from the outer housing thereby defining a space termed the first filtration zone. The inner assembly itself further defines a second space termed the second filtration zone.

The inner assembly may further include a cylinder at the boundary between the first and second filtration zones. This cylinder may partially enclose the second filter element and have a plurality of perforations allowing flow of LPG between the first and second filtration zones.

A filter according to the invention further includes a first filter element removably positioned between the outer housing and the inner assembly in the first filtration zone. The first filter element is comprised by an LPG permeable enclosure enclosing a chemical contaminant entrapping agent such as a molecular sieve, activated carbon or aluminum oxide. The LPG permeable enclosure may comprise a cellulose-based material or a metallic mesh. The enclosure may completely surround the chemical contaminant entrapping agent or provide only partial enclosure of the agent. A second filter element is removably contained within the second filtration zone and includes a porous filtration material through which LPG can flow but particulate material may be entrapped. The first and second filter elements are constructed and arranged such that the respective elements may communicate with each other at a boundary between the first and second filtration zones. A filter according to the present invention may further include a sensor in communication with LPG at the outlet for indicating the contaminant level of LPG exiting the filter.

The present invention also includes a method for removing contaminants from LPG. The method includes the step of selecting a filter including a first filter element comprised by a chemical contaminant entrapping agent for initially removing chemical contaminants from the LPG. A second filter element is also selected for subsequently removing particulate contaminants from the LPG. In one embodiment, the first filter element includes a molecular sieving agent such as a zeolite. The method according to the invention further includes the step of routing a flow of LPG through the filter so that chemical contaminants and particulate contaminants are sequentially removed from the LPG. The method may include the further step of monitoring the LPG exiting the filter to determine the level of contaminants remaining in the LPG.

The invention is further directed to a process for removing a chemical contaminant from LPG. The process includes the step of contacting the LPG with a chemical contaminant entrapping agent selected from the group consisting of crystalline aluminosilicates, crystalline aluminum-magnesium silicates, crystalline aluminophosphates, activated carbons, charcoals and aluminum oxide, thereby to entrap the chemical contaminants in the agent.

In another embodiment, the invention is a process for removing a low molecular weight amine from LPG. The process include the step of contacting the LPG with a chemical contaminant entrapping agent selected from the group consisting of crystalline aluminosilicates, crystalline aluminum-magnesium silicates, crystalline aluminophosphates, activated carbons, charcoals and aluminum oxide, thereby to entrap the low molecular weight amine in the agent.

Various other features, objects, and advantages of the invention will be made apparent to those skilled in the art from the accompanying drawings and detailed description thereof.

### BRIEF DESCRIPTION OF THE DRAWINGS

The previously stated features and advantages of the present invention will be apparent from the following detailed description as illustrated in the accompanying drawings wherein like reference numerals throughout the various figures denote like structural elements, and in which:

FIG. 1 is a general schematic showing a filter according to the invention positioned downstream of an LPG storage tank on a device, such as a fork lift, and upstream of a converter, or regulator, providing LPG to an end application such as an engine;

FIG. 2 is a general schematic showing a filter according to the invention placed downstream of a bulk fuel tank and upstream of an LPG dispensing station;

FIG. 3 is a general schematic showing a filter according to the invention placed downstream of a bulk LPG storage tank and upstream of a regulator/vaporizer which supplies LPG to a plant apparatus;

FIG. 4 is cross-sectional view of a preferred embodiment of a filter according to the present invention;

FIG. 5 is a cross-sectional view of a second embodiment of a filter according to the present invention;

FIG. 6 is a side plan view of a cylinder to partially enclose the second filter element having a plurality of perforations through which LPG may flow;

FIG. 7 is data obtained from FT-IR spectroscopic analysis of residue from the interior of an LPG regulator;

FIG. 8 is data obtained from FT-IR spectroscopic analysis of residue from the inside of an LPG storage tank;

FIG. 9 is data obtained from FT-IR spectroscopic analysis of a residue film formed on a diaphragm;

FIG. 10 is data obtained from FT-IR spectroscopic analysis of an LPG sample, prefiltered, described in Example 2;

FIG. 11 is data obtained from FT-IR spectroscopic analysis of an LPG sample described in Example 2, after 10 gallons of LPG flow through a filter according to the invention;

FIG. 12 is data obtained from FT-IR spectroscopic analysis of an LPG sample described in Example 2 after 100 gallons of the LPG flow through a filter according to the invention; and

FIG. 13 is data obtained from FT-IR spectroscopic analysis of an LPG sample described in Example 2, after 500 gallons of LPG flow through a filter according to the invention.

### DETAILED DESCRIPTION OF THE INVENTION

I. In General

Before the present invention is described, it is understood that this invention is not limited to the particular apparatus and methodology described, as these may vary. It is also to be understood that the terminology used herein is for the purpose of describing particular embodiments only, and is not intended to limit the scope of the present invention which will be limited only by the appended claims.

It must be noted that as used herein and in the appended claims, the singular forms “a”, “an”, and “the” include plural reference unless the context clearly dictates otherwise. Thus, for example, reference to “a sensor” includes a plurality of such sensors and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are now described. All publications, patents and published patent applications mentioned herein are incorporated herein by reference for the purpose of describing and disclosing the chemicals, apparatus, instruments, statistical analysis and methodologies which are reported in the publications which might be used in connection with the invention. Nothing herein is to be construed as an admission that the invention is not entitled to antedate such disclosure by virtue of prior invention.

II. The Invention

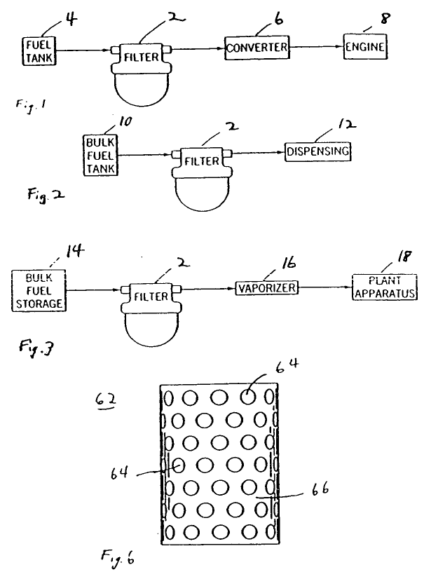

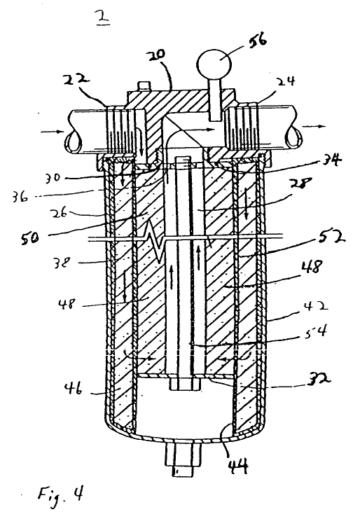

The present invention is a filter and method of using the filter applicable to a variety of settings where LPG is handled, stored or consumed as an energy source. As shown in FIG. 1, a filter 2 according to the invention is positioned downstream of an LPG storage tank 4, and upstream of a converter 6, or regulator, providing LPG to an end application such as an engine 8. FIG. 1 is illustrative of the LPG system on a mobile device, such as a fork lift. An alternative arrangement is shown in FIG. 2 where filter 2 is used to remove contaminants from LPG in an in-line arrangement where filter 2 is placed downstream of a bulk LPG storage tank 10 and upstream of an LPG dispensing station 12. In yet another embodiment, FIG. 3 shows filter 2 placed downstream of a bulk LPG storage tank 14 and upstream of a regulator/vaporizer 16 which supplies LPG to a plant apparatus 18. All of these particular applications, and others, are certainly within the scope of use for the present invention.

Referring now to FIG. 4, a preferred embodiment of a filter 2 according to the invention is shown. Filter 2 includes an upper housing 20 including an inlet 22 capable of receiving LPG from upstream of filter 2. Upper housing 20 also includes an outlet 24 capable of conveying LPG downstream of filter 2 after the LPG has passed through filter 2. Upper housing 20 may be secured in an in-line arrangement by any technique known in the field, including threads as shown in FIG. 4.

A lower housing 26 is removably attached to upper housing 20. Lower housing 26 communicates with inlet 22 and may be secured to upper housing 20 by any suitable technique known in the field, including threads as shown in FIG. 4, reminiscent of a replaceable screw-on engine oil filter.

Filter 2 further contains an inner assembly 28 that includes first and second ends, 30, 32, respectively. Inner assembly 28 is removably attached to the upper housing 20 at first end 30 by threads or other equivalent means known in the field. A sealing ring 34 may be further included on first end 30 to ensure LPG does not leak between inlet 22 and outlet 24. Inner assembly 28 further communicates at first end 30 with outlet 24 so that LPG may flow through, in general, first end 30 to outlet 24. First end 30 further includes apertures 36 to effectuate this flow of LPG.

Inner assembly 28 is disposed within and spaced apart from outer housing 26 thereby defining a first filtration zone 38, which physically comprises the zone between the outer housing 26 and the inner assembly 28. Construction of the filter is such that LPG may enter inlet 22 and follow an unimpeded flow into first filtration zone 38. Inner assembly 28 further defines a second filtration zone 40 within the space between first end 30 and second end 32.

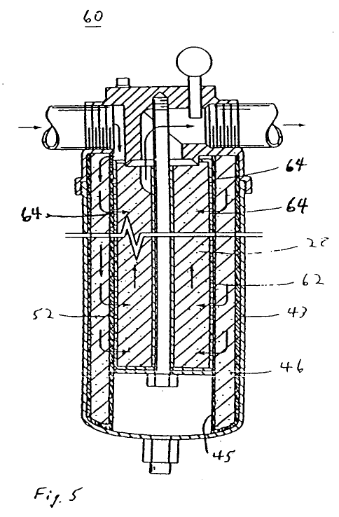

Still referring to FIG. 4, a first filter element 42 is removably positioned between outer housing 26 and inner assembly 28 so that first filtration zone 40 is substantially filled by first filter element 42. First filter element 42 is constructed of an LPG permeable enclosure 44 enclosing a chemical contaminant entrapping agent 46. LPG permeable enclosure 44 may be formed from LPG-resistant porous paper, cardboard, fabric, plastic or a metallic mesh. Enclosure 44 is preferably formed from a brass metallic mesh. Brass mesh is shown to be useful in Example 2 below. Materials suitable for construction of LPG permeable enclosure 44 should have a minimum porosity at least adequate to prevent chemical contaminant entrapping agent 46 from escaping to the outside of LPG permeable enclosure 44. In a preferred embodiment, enclosure 44 completely surrounds chemical contaminant entrapping agent 46, as shown in FIG. 5. However, it is within the scope of the invention for enclosure 44 to only partially surround chemical contaminant entrapping agent 46 such that enclosure 44 may, at a minimum, provide only a barrier between agent 46 and inner assembly 28. In the most minimal case, enclosure 44 would be a sleeve surrounding inner assembly 28 and chemical contaminant entrapping agent 46 would occupy the space between enclosure 44 and the wall of lower housing 26.

The term “chemical contaminant,” as defined herein, refers to molecules that are non-LPG-derived but introduced into LPG during chemical cracking processes and associated side reactions thereof. In addition, chemical contaminants further include those molecules introduced by contact of LPG with non-LPG derived chemicals during transport or storage of the LPG. The present inventors have made the unique finding that it is these chemical contaminants, primarily low molecular weight amines or, to be used equivalently herein, small molecule amines, which are substantially responsible for undesirable residue buildup in LPG fuel systems. “Small molecule” and “low molecular weight” are defined herein as those molecules having a molecular weight of 300 or less. The invention described and claimed herein effectively reduces and/or removes these respective chemical contaminants to provide LPG of heightened quality.

The term “chemical contaminant entrapping agent” is defined herein as a material that entraps chemical contaminants into or onto a porous environment. The term “entrapping” shall include the activities of absorbing, adsorbing, filtering, sieving and functional equivalents thereof. Suitable materials have the ability to entrap chemical contaminants that are low molecular weight species as exemplified by ethyl amine. Small amines are common chemical contaminants of LPG as described above and Example 1 experimentally demonstrates. Such small molecule chemical contaminants may enter cavities within the chemical contaminant entrapping agent and become entrapped, whereas larger molecules, such as branched chain hydrocarbons, cannot enter the porous structure and flow through the chemical contaminant entrapping agent.

The term “molecular sieving agent” refers to a subclass of chemical contaminant entrapping agents useful in the present invention and is herein broadly defined as including microporous structure composed of either crystalline aluminosilicates, chemically similar to clays and feldspars and commonly termed zeolites, or crystalline aluminophosphates. Aluminum-magnesium silicates, commonly termed attapulgite clays, are further illustrative of such materials useful in the present invention. Pore sizes for the above materials may vary considerably with to 10 angstroms being common pore sizes. The outstanding characteristic of these materials is their ability to undergo dehydration with little or no change in crystalline structure. The dehydrated crystals are interlaced with regularly spaced channels of molecular dimensions, which can comprise 50% of the total volume of the crystals. The empty cavities in activated molecular sieve crystals have a strong tendency to recapture the water molecules that have been driven off by activation processes. This tendency is so strong that if no water is present they will accept any material that can get into the cavity. However, only those molecules that are small enough to pass through the pores of the crystals can enter the cavities and be entrapped, absorbed or adsorbed on the interior surfaces.

Zeolites are particularly attractive sieving agents for use in the present invention because, although zeolites do occur naturally, they may also be synthesized to exacting porosity requirements. Zeolites are therefore the preferred sieving agent for use herein. Uniform porosity may facilitate selective removal of molecules up to a specific three dimensional size. The porosity of a zeolite useful in the invention will be in the range of about 2 to 100 angstroms, with 4 to 20 angstroms preferred and 10 angstroms most preferred. A suitable zeolite is available from W.R. Grace and Company under the trade name Formed Molecular Sieve having an average porosity of 10 angstroms. Although chemical contaminants are described above as being entrapped, absorbed or adsorbed onto a sieving agent, no single theory of operation is adopted or claimed herein.

In addition to the above described molecular sieving agents, other suitable chemical contaminant entrapping agents having microporous structure useful in the present invention include activated carbons or charcoals. “Activated carbons” and “charcoals” are herein broadly defined as amorphous forms of carbon characterized by high adsorptivity for many gases, vapors, and colloidal solids. Such carbons are obtained by the destructive distillation of wood, nut shells, animal bones, or other carbonaceous material. Activation may be by heating with steam or carbon dioxide resulting in a porous “honey comb” internal structure. Additional agents useful in the present invention include the adsorptive aluminum oxide (Al₂O₃) material described in U.S. Pat. No. 6,531,052 to Frye et al., as Example 3 further describes below.

Now continuing the description of the preferred embodiment shown in FIG. 4, inner assembly 28 includes and supports a second filter element 48 which is removably positioned within second filtration zone 40 and is comprised by a porous filtration material 50 wherein the first and second filter elements 42, 48, respectively, communicate with each other at a boundary 52 between the first and second filtration zones 38, 40. Porous filtration material 50 will have a porosity in the range of about 5-50 microns and may be formed from a material such as paper, cardboard, plastic or metal in the form of a mesh. Paper is preferred. Porous filtration material 50 may be shaped in any manner known in the field to provide increased surface area for contact with LPG (e.g., corrugated paper). First end 30 and second end 32 of inner assembly 28 are structured to support second filter element 48. Second filter element 48 may be secured within inner assembly 28 by a fastening assembly 54 passing through second end 32 and second filter element 28 to be accepted by first end 30 (shown in FIG. 4) or upper housing 20 (alternatively shown in FIG. 5).

FIG. 4 also shows that filter 2 may optionally include a sensor 56 in communication with exiting LPG at the outlet 24 for indicating a measurable quality of LPG exiting outlet 24. Sensor 56 may be of several varieties, although a preferred sensor will provide data regarding the level of chemical and particulate contaminants remaining in filtered LPG. However, sensor 56 may also be of simple design known in the field for simply monitoring LPG flow rate and/or volume of LPG pumped. A complex sensor for monitoring chemical/particulate contaminants may be achieved with a sensor arrangement including analytical instrumentation having an infrared, UV-visible, or atomic absorption spectroscopy component for sample analysis. Many such suitable sensor arrangements may be envisioned and are well known in the field.

Now referring to FIG. 5, a second embodiment filter 60 according to the invention is shown wherein inner assembly 28 includes a cylinder 62 at the boundary 52 between the first and second filtration zones, 38, 40. Cylinder 62 partially encloses second filter element 48 and has a plurality of perforations 64 that allow LPG to flow between the first and second filtration zones, 38, 40 respectively. As shown in FIG. 5, cylinder 62, may itself be supported by the first end 30 and second end 32 of inner assembly 28.

FIG. 5 further illustrates a first filter element 43 having an LPG permeable enclosure 45 incompletely enclosing chemical contaminant entrapping agent 46. It can be observed that, in this second embodiment, LPG permeable enclosure 45 is not closed at the region immediately adjacent to upper housing 20. An enclosure 45 of this design is particularly useful where the user desires the ability to discard exhausted chemical contaminant entrapping agent and replace it with fresh agent while repeatedly utilizing the same enclosure 45. Where an enclosure 45 does not completely enclose an agent 46, construction may be of metallic mesh to promote structural stability.

FIG. 6 shows a side plan view of cylinder 62 having a plurality of perforations 64 formed in a wall 66. It is intended that cylinder 62 may be optionally included in the invention where a longer contact time between LPG and the chemical contaminant entrapping agent is required. Furthermore, the size and number of perforations 64 in cylinder 62 may be varied to achieve an optimal LPG flow rate versus chemical contaminant level. Optional use of cylinder 62 provides flexibility of use and allows the user to tailor the filter and method to a particular application. Factors influencing the use of cylinder 62 and its particular configuration may include, but are not limited to, pore size of chemical contaminant entrapping agent used, LPG flow pressure and flow rate, and desired minimum/maximum contaminant level permissible.

Filters constructed according to the invention are intended to operate under the high pressures which LPG is stored, handled and dispensed. In particular, it is desirable that a filter be capable of operating at inlet pressures as required by applicable Underwriter's Laboratory (UL) standards, National Fire Protection Association (NFPA) standards (e.g., NFPA Standard No. 58), and other regulatory agencies, U.S. or foreign, known to exert authority over devices in the present field. Construction of upper housing 20, lower housing 26, inner assembly 28 and cylinder 62 is preferably of die cast aluminum. Die cast aluminum is especially preferred where weight of a filter is of concern, such as on a fork lift. However, construction of the above-noted elements based on steel, brass, or equivalent alloys is also possible.

It should be further noted that relative size and configuration of a filter according to the invention may vary widely as the filter and method disclosed herein are intended to have use in and on a wide variety of applications. The particular embodiments discussed above are particularly well-suited for use in combination with LPG-consuming engines. In particular, the invention contemplates LPG-consuming engines powering mobile equipment, such as fork lifts. However, the invention also encompasses filters finding alternative use, as exemplified by FIGS. 1-3 wherein the invention is used in connection with a bulk LPG dispensing plant, an LPG production facility, or an LPG retail storage tank site, collectively, LPG-handling facilities. Inclusion of the invention at these facilities provides the advantage of reducing or removing chemical contaminants at the bulk fuel level thereby providing a significant benefit in fuel quality to subsequent LPG consumers.

The basic method of practicing the present invention will now be described. A user will first select a filter 2 according to the invention described herein where the filter 2 includes a first filter element 42 including a chemical contaminant entrapping agent 46. First filter element 42 is selected to initially remove chemical contaminants from LPG. Such filter will also include a second filter element 48 for subsequently removing particulate contaminants from LPG. The user then positions the filter in an in-line arrangement, perhaps as shown in FIGS. 1-3, and directs a flow of LPG through first filter element 42. Chemical contaminants are removed and the LPG is subsequently routed to the second filter element 48. Particulate contaminants are removed at second filter element 48 and filtered LPG is finally routed downstream of filter 2. Manipulation and placement of filter 2 within the in-line arrangement are well within the skill of a worker in this field.

The present invention calls for the first and second filter elements 42, 48, to be removable for cleaning or replacement by the user at regular maintenance intervals. Such manipulations may be effectuated through the inclusion of threaded and rubber sealed attachment points between housing elements, for example, the upper housing 20 and lower housing 26 may be threaded so that they may be removably separated as shown in FIGS. 4 and 5. The general concept may be likened to that of a standard oil filter included on a gasoline engine. It is envisioned that the lower housing 26 including the first and second filter elements 42, 48 (with or without the cylinder 62), may be disposable as a unit when the respective filter elements 42, 48 are exhausted or clogged. Upper housing 20 may remain as a permanent fixture within whatever in-line arrangement the filter is being used. Lower housing 26 may be reused and the first and second filter elements 42, 48 replaced individually, or as a unit. As well, enclosure 44 of first element 42 may be reused while agent 46 is discarded and replaced with fresh agent 46, as described above. Convenient replacement of agent 46 may be facilitated where the enclosure 45 does not completely enclose agent 46 as in the embodiment shown in FIG. 5 and described in detail above. Furthermore, the replacement schedule for replacing the filter elements may be based on a known life expectancy for the respective filter elements based on use conditions (e.g., flow rate, contaminant concentrations) or, alternatively, be determined by a downstream measure of LPG quality such as that provided by sensor 56 or other suitable qualitative detector.

The usefulness of the above-described invention will now be demonstrated by way of the following informative examples. These examples are in no way meant to limit the scope of the invention and are included for illustrative purposes only.

### III. EXAMPLES

### Example 1

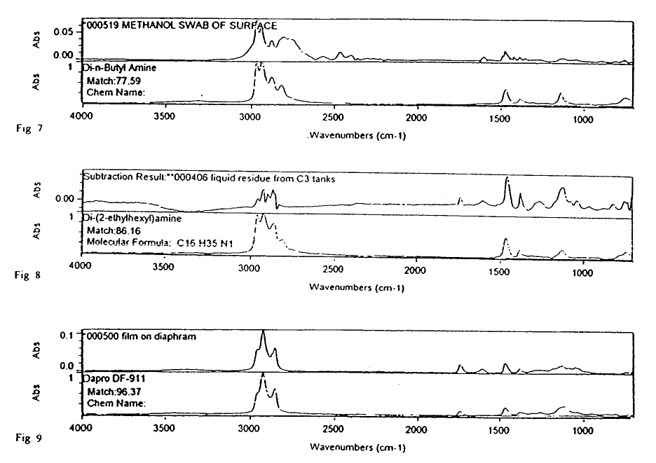

Components of residue buildup in various LPG handling equipment, including regulators and storage tanks, were identified by Fourier Transform Infrared (FT-IR) spectroscopic analysis and computer comparison to a library of known infrared spectra available as Hummel Infrared Standards from Thermo Nicolet Corp. A Nicolet 730 FT-IR spectrometer equipped with a SenSir Durascope was used to gather and analyze the spectra shown in FIGS. 7-9. The contaminants identified are presented for illustrative purposes only and are by no means the only chemical contaminants present in commercially available LPG that may result in residue buildup.

Referring to FIG. 7, the upper spectra shows infrared data obtained by swiping the residue from the interior of an LPG regulator with a methanol-coated swab and subtracting methanol background. The lower spectra shows the closest match identified by the analysis software (confidence level=77.59; scale of 0-100). The closest match is di-n-butyl amine, a small organic molecule, which is evidently a contaminant introduced in the manufacturing process of this LPG sample.

Referring to FIG. 8, the upper spectrum shows infrared data obtained by sampling the residue from the inside of a storage tank. The lower spectra shows the closest match identified by the analysis software (confidence level=86.16). The closest match was di-(2-ethyl hexyl) amine, another small organic molecule believed to be introduced into the LPG in the manufacturing process.

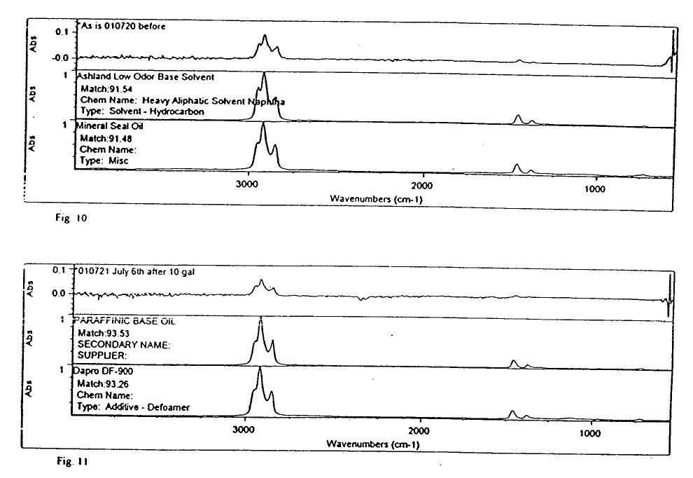

Referring to FIG. 9, the upper spectra shows the infrared data obtained by sampling film formed on a diaphragm. The lower spectra shows the closest match identified as Dapro DF-911, an amine-based commercial product useful in defoaming and anti-filming applications (confidence level=96.37). This molecule may have been introduced into the LPG during manufacture or may have become a contaminant in subsequent handling.

### Example 2

A study was conducted on a filter, described in detail below, to determine its usefulness in removing contaminants from LPG. A circular flow circuit was constructed wherein LPG was pumped from a bulk storage tank by a pump with a volume recording feature to the inlet of the filter. Filtered LPG then exited the filter at the outlet and proceeded in a return line to the bulk storage tank. An LPG sampling port was provided at the bulk storage tank so that samples could be withdrawn at data points corresponding to the volume of LPG pumped through the filter. The bulk storage tank contained approximately 800 gallons of LPG. With this circular pumping arrangement, the contaminant level of the LPG in the bulk storage tank was expected to be reduced in relation to the volume of LPG pumped through the filter (i.e., the larger the volume of LPG pumped through the filter, the lower the contaminant concentration of LPG in the bulk storage tank).

All filter components, except the chemical contaminant removing first filter element, were available in the form of a coalescing filter manufactured by Pall Process Filtration Co., and distributed by Enpro, Inc., Addison, Ill. under cat. no. PC401-L-G16H13. A first filter element was formed from fine brass mesh and contained 2 lbs. of zeolite, available from W.R. Grace and Co. under the tradename Formed Molecular Sieve having a porosity of approximately 10 angstroms. The coalescing filter included a second filter element having a corrugated paper filter with approximate porosity of 30 microns, available from Enpro, Inc., cat no. RGN1FN250. The flow rate of the system was maintained at approximately 10 gallons/minute.

A pre-filter sample of LPG was collected and then subsequent post-filter samples were collected at the sampling port after 10, 100, and 500 gallons of LPG had flowed through the filter. These samples were submitted for FT-IR spectroscopic analyses as described above in Example 1 and the resultant spectra are shown in FIGS. 10-13, described below.

FIG. 10 represents spectral data for the LPG sample obtained pre-filtering. The upper spectra shows the infrared data obtained for the sample after necessary subtractions and the lower two spectra show the closest matches as identified by the computer software. The matches are a base solvent (confidence=91.54) and mineral seal oil (confidence=91.48). Chemical contaminants were evident in this sample.

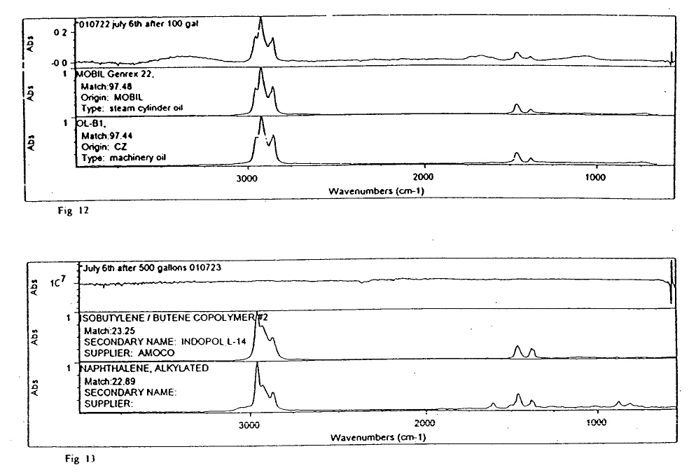

FIG. 11 shows spectral data for an LPG sample obtained after 10 gallons of LPG had been run through the filter. The upper spectra shows the infrared data obtained for the sample after necessary subtractions and the lower two spectra show the closest matches as identified by the computer software. The matches are a paraffinic base oil (confidence=93.53) and Dapro DF-900 (confidence=93.26), an amine-based defoamer. Most importantly, the absorbance for the peaks in the range of 2700-3000 cm⁻¹ wavenumbers has noticeably decreased from the pre-filter sample shown in FIG. 10.

FIG. 12 shows spectral data for an LPG sample obtained after 100 gallons of LPG have been run through the filter. The upper spectra shows the infrared data obtained for the sample after necessary subtractions and the lower two spectra show the closest matches as identifed by the computer software. The closest matches are MOBIL Genrex 22 (confidence=97.48) and OL-B1 (confidence=97.44). Again, it can be observed that the absorbance of the peaks in the range of 2700-3000 cm⁻¹ wavenumbers has noticeably decreased from the pre-filter sample shown in FIG. 10 and the sample in FIG. 12.

FIG. 13 shows spectral data for an LPG sample obtained after 500 gallons of LPG have been run through the filter. The upper spectra shows the infrared data obtained for the sample after necessary subtractions and the lower two spectra show the closest matches as identifed by the computer software. The closest matches are isobutylene/butene copolymer #2 (confidence=23.25) and alkylated naphthalene (confidence=22.89). It should be noted that the confidence levels on identifying the closest matches are now far below what is considered reliable and contaminants have apparently been effectively removed by the filter. It is further evident that the absorbance peaks in the range of 2700-3000 cm⁻¹ wavenumbers have decreased to the point where the concentration of contaminating compounds has decreased to the point of being negligible, or at least all but undetectable by the detection techniques used here.

### Example 3

This example describes engine performance tests conducted with a filter constructed substantially as described in Example 2 and demonstrates the invention's usefulness in dramatically reducing contaminant buildup within components of an LPG-consuming fuel system. In contrast to the filter in Example 2, the respective filter element in this example included a chemical entrapping material comprising aluminum oxide (Al₂O₃) available under the federally registered trademark SELEXSORB SAS6 from Alcoa World Alumina, LLC. (Vidalia Works, Vidalia, La.) and described in U.S. Pat. No. 6,531,052. The inventors discovered this material to have contaminant small molecule amine adsorbent properties. Approximately 2 lbs. of the contaminant adsorbent material were placed within a cotton mesh sack to form the removable first filter element to be inserted as a unit in the filter.

The filter according to the invention was placed in-line between an LPG tank and an Impco model J regulator upstream of a standard air valve mixer that provided air/fuel mixture to a Nissan 1.3L engine. The engine powered a 16 KW generator set connected to an electrical load bank where engine load could be varied. The system was operated in eight (8) hour intervals for a total of 73.4 hours. LPG tanks were weighed before and after intervals to determine the mass of LPG used per 8 hour interval. A total of 363 lbs. of LPG was consumed by the 1.3L engine over the course of the test. Engine load was varied during the total period and it was empirically determined that the test was equivalent to approximately one hundred (100) hours of normal fork truck use.

Following the 73.4 hour run time, the engine was disassembled and individual engine parts were scrutinized for contaminant buildup. Multiple samples were subsequently obtained by swabbing the interior surfaces of the test regulator and these samples were submitted to FT-IR spectroscopic analyses, as generally described above in Example 1. There were no discernible chemical contaminants, particularly small molecule amines, detected on the interior surfaces of the regulator by the methodology described herein. In comparison, the interior surfaces of regulators from engine systems lacking the present fuel filter exhibited chemical contaminant buildup, namely, the gummy, sticky residue of small molecule amines identified and described in the previous Examples. These results demonstrate the present invention's utility in reducing small molecule contaminant buildup in an LPG fuel system and, most importantly, the usefulness of the present invention in contributing to an improved engine durability standard by virtue of providing LPG of heightened quality.

While the invention has been described with reference to preferred embodiments, those skilled in the art will appreciate that certain substitutions, alterations, and omissions may be made without departing from the spirit of the invention. Accordingly, the foregoing description is meant to be exemplary only and should not limit the scope of the invention set forth in the following claims.

1. A method for removing an amine contaminant from LPG, comprising the step of contacting said LPG with a molecular sieving agent thereby to remove the amine contaminant from the LPG.

2. The method according to claim 1 wherein said molecular sieving agent is selected from the group consisting of crystalline aluminosilicates, crystalline aluminum-magnesium silicates and crystalline aluminophosphates.

3. The method according to claim 1 wherein said molecular sieving agent is a synthetic zeolite.

4. The method according to claim 3 wherein said synthetic zeolite has a porosity range from about 2 angstroms to about 10 angstroms.

5. The method according to claim 3 wherein said synthetic zeolite has a porosity less than about 5 angstroms.
